(19) United States
(12) Patent Application Publication
(10) Pub. No.: US 2014/0028429 A1
(43) Pub. Date: Jan. 30, 2014

(54) MULTILAYERED CHIP-TYPE POWER INDUCTOR AND A PRODUCTION METHOD THEREFOR

(71) Applicant: Dongsook Sinn, Seoul (KR)

(72) Inventor: Dongsook Sinn, Seoul (KR)

(73) Assignee: FCELL TECH CO., LTD, Seoul (KR)

(21) Appl. No.: 14/110,746

(22) PCT Filed: Apr. 10, 2012
(86) PCT No.: PCT/KR2012/002721

§ 371 Date: Oct. 9, 2013

(30) Foreign Application Priority Data
Apr. 11, 2011 (KR) 10-2011-0033326
Apr. 10, 2012 (KR) 10-2012-0037193

(51) Int. Cl. H01F 27/29; H01F 41/10

(52) U.S. Cl. CPC H01F 27/29; H01F 41/10
USPC 336/192; 29/602.1

(57) ABSTRACT

The present invention relates to a multilayered chip-type power inductor and to a production method therefor. A multilayered chip-type power inductor is disclosed which comprises: a ferrite magnetic body layer formed from Mn—Zn based or Mn—Mg—Zn based ferrite; an internal electrode which is formed from copper, and is formed in the shape of a coil on the inside of the ferrite magnetic body layer; and an external electrode which is formed either on two side surfaces or on the upper and lower surfaces of the ferrite magnetic body layer, and is electrically connected to the internal electrode that is exposed either on the two sides surfaces or on the upper and lower surfaces of the ferrite magnetic body layer. Also, disclosed is a multilayered chip-type power inductor production method comprising: a green laminate forming step involving the lamination of green compacts comprising internal electrodes which are formed by moulding a Mn—Zn based or Mn—Mg—Zn based ferrite powder into a sheet shape and printing copper onto the surface thereof; a green laminate sintering step in which a sintered laminate is formed by sintering the green laminate in a reducing atmosphere; and a step of forming external electrodes by forming external electrodes that are respectively connected to the internal electrode that is exposed either on two side surfaces or on the upper and lower surfaces of the sintered laminate.

### TECHNICAL FIELD

The present invention relates to a multilayered chip-type power inductor and a method of manufacturing the same

### BACKGROUND ART

A multilayered chip-type power inductor comprises a ferrite magnetic layer formed by stacking and an internal electrode formed in a regular pattern in the ferrite magnetic layer. The multilayered chip-type power inductor is formed by sintering the ferrite magnetic layer and the internal electrode together. Also, the multilayered chip-type power inductor is capable to comprise a non-magnetic layer between the ferrite magnetic layers. The ferrite magnetic layer is formed by Ni—Cu—Zn based material, the internal electrode is formed mainly by silver (Ag).

The internal electrode is formed mainly by silver for high electrical conductivity, silver is high price because of noble metal and is affecting to the manufacturing cost a lot. Therefore, it has been researched to substitute material of the internal electrode from silver to copper. However, there is a problem that a surface of copper is easily oxidizing in sintering process. Since copper of the internal electrode reacts with copper of the ferrite magnetic layer, there is a problem that the internal electrode cannot act as an electrode. If the ferrite magnetic layer is formed by Ni—Zn based material without copper, a sintering temperature of the ferrite magnetic layer is required above 1100° C. and. Accordingly, there is a problem that copper of the internal electrode is melting.

### DISCLOSURE OF THE INVENTION

### Technical Problem

An aspects of the present invention provide a multilayered chip-type power inductor and a method of manufacturing thereof which an internal electrode can be made of copper.

### Technical Solution

According to an aspect of the present invention, the multilayered chip-type power inductor which substantially overcomes one or more of the problems of the related art is provided. The multilayered chip-type power inductor includes a plurality of ferrite magnetic layer made of Mn—Zn based ferrite or Mn—Mg—Zn based ferrite and stacked; an internal electrode made of copper, shaped as a coil shape inside the ferrite magnetic layer and exposed from both side surfaces or upper and lower surfaces of the ferrite magnetic layer; and an external electrode coupled electrically to the internal electrode which are exposed from both side surface or upper and lower surfaces of the ferrite magnetic layer.

The ferrite magnetic layer may be made of MnO 20˜40 mol %, MgO 0˜10 mol %, Fe₂O₃ 50˜55 mol %, ZnO 9˜25 mol %. An using frequency domain of the ferrite magnetic layer may be 1˜10 MHz in case that the ferrite magnet layer is made of Mn—Zn based ferrite and the using frequency domain of the ferrite magnetic layer is 1˜20 MHz in case that the ferrite magnet layer is made of Mn—Mg—Zn based ferrite.

The ferrite magnetic layer may have a grain size of 0.2 μm˜1.0 μm.

According to an aspect of the present invention, a method of manufacturing a multilayered chip-type power inductor which substantially overcomes one or more of the problems of the related art is provided. The method of manufacturing a multilayered chip-type power inductor may include a green stacked body forming step forming the green stacked body by stacking green formed bodies which are formed by forming Mn—Mg—Zn based ferrite powders into a plate shape and forming an internal electrode on the plate shape by printing copper; the green stacked body sintering step forming a sintered stacked body by sintering the green stacked body in a reducing atmosphere; and external electrodes forming step forming the external electrodes connected respectively to the internal electrode to be exposed from both side surfaces or upper and lower surfaces of the sintered stacked body.

Green stacked body sintering step may be proceeded in a sintering temperature range of 900° C.˜1030° C. Also, Green stacked body sintering step may be proceeded in a nitrogen atmosphere or in a mixed atmosphere of nitrogen and hydrogen. Green stacked body sintering step may be proceeded in an atmosphere of 10⁻¹² to 10⁻⁶ atm of an oxygen partial pressure.

The sintered stacked body may comprise the ferrite magnetic layer and the internal electrode which is formed in a coil shape inside the ferrite magnetic layer and is exposed to from both side surfaces or upper and lower surfaces of the ferrite magnetic layers, the external electrodes may connect to the internal electrode exposed from both side surfaces or upper and lower surfaces of the ferrite magnetic layer. Also, the ferrite magnetic layer may have a grain size of 0.2 μm˜1.0 μm.

### Advantageous Effects

According to a multilayered chip-type power inductor and a method of manufacturing thereof of the present invention, it can prevent for copper to oxidize and to react with the ferrite magnetic layer by changing the composition of the ferrite magnetic layer and the sintering conditions

Therefore, the multilayered chip-type power inductor can be manufactured to increase a permeability and an using frequency domain. Also, the multilayered chip-type power can be manufactured economically by using copper of a relatively low price.

### BRIEF DESCRIPTION OF THE DRAWINGS

FIG. 1 is a vertical cross-sectional view of a multilayered chip-type power inductor according to one embodiment of the present invention.

FIG. 2 is a process chart of a method of manufacturing a multilayered chip-type power inductor according to one embodiment of the present invention.

FIG. 3 is a SEM photography of a multilayered chip-type power inductor according to embodiment 1 of the present invention.

FIG. 4 is a graph of a permeability property of a multilayered chip-type power inductor according to embodiment 1 of the present invention.

FIG. 5 is a graph of a permeability property of a multilayered chip-type power inductor according to embodiment 4 of the present invention.

FIG. 6 is a SEM photography of an interface between a multilayered chip-type power inductor and an internal electrode formed by copper of embodiment 4.

### MODE FOR CARRYING OUT THE INVENTION

Hereinafter, a multilayered chip-type power inductor and a method of manufacturing thereof of the present invention will be described in detail with embodiments and the accompanying drawings.

First of all, the multilayered chip-type power inductor according to one embodiment of the present invention is described.

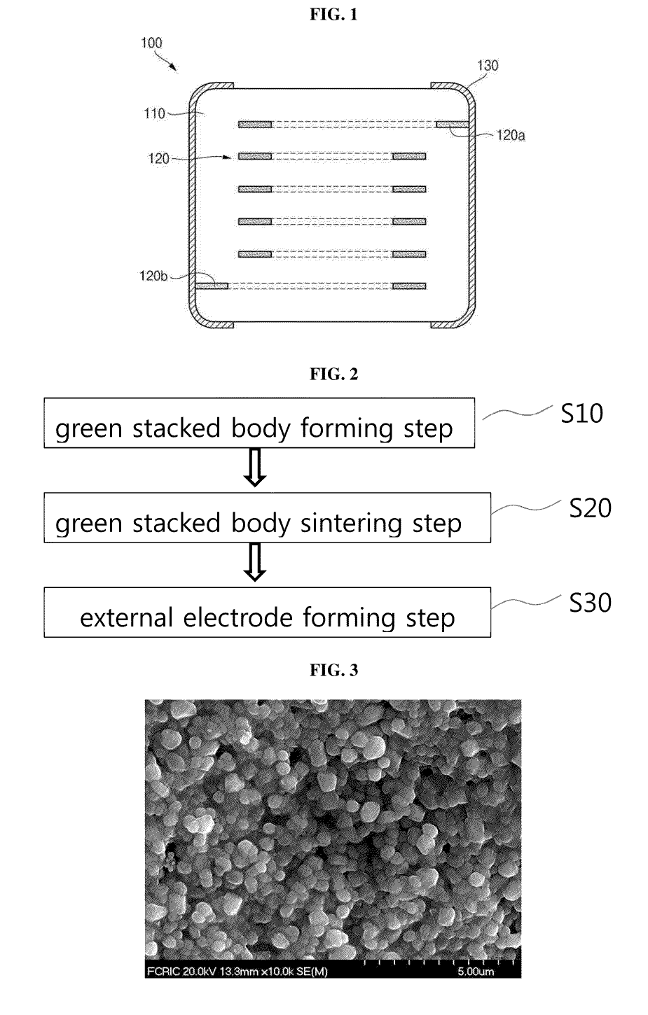

FIG. 1 is a vertical cross-sectional view of a multilayered chip-type power inductor according to one embodiment of the present invention.

Referring to FIG. 1, the multilayered chip-type power inductor 100 includes a ferrite magnetic layers 110, an internal electrode 120 and external electrode 130. In the present invention, the multilayered chip-type power inductor may comprise a multilayered chip-type transformer.

Although not shown in detail, the multilayered chip-type power inductor 100 may include a non-magnetic layer formed between the ferrite magnetic layers 110 and an internal connecting electrode (not drawn) formed inside the non-magnetic layer. The internal connecting electrode connects electrically the internal electrode 120 of the ferrite magnetic layer 110 which is disposed above and below the non-magnetic layer respectively. The internal connecting electrode may be formed in a via hole form in the ferrite magnetic layer 110 which is located between the internal electrode 120. Since the internal connecting electrode is a common element in the multilayered chip-type power inductor, it is not shown in detail in the drawing.

The ferrite magnetic layer 110 is made of Mn—Zn based ferrite or Mn—Mg—Zn based ferrite.

The ferrite magnetic layer 110 is made of MnO 20˜40 mol %, MgO 0˜10 mol %, Fe₂O₃50˜55 mol %, ZnO 9˜25 mol %. The ferrite magnetic layer 110 dose not comprise Mg in case of Mn—Zn based material, and comprises Mg in case of Mn—Mg—Zn based material. If an amount of ZnO is small or large, there is a problem that a grain size of the ferrite magnetic layer 110 is reduced and that a permeability of the ferrite magnetic layer 110 become lower. If an amount of MgO is large, there is a problem that the grain size of the ferrite magnetic layer 110 is reduced and that the permeability of the ferrite magnetic layer 110 become lower. If an amount of Fe₂O₃ is small, there is a problem that the grain size of the ferrite magnetic layer 110 is reduced and that the permeability of the ferrite magnetic layer 110 becomes lower. If an amount of Fe₂O₃ is large, there is a problem that a loss of the permeability is increased and that a frequency of the ferrite magnetic layer 110 becomes lower. MnO is comprised as a residual quantity.

The ferrite magnetic layer 110 dose not comprise copper. Therefore, the ferrite magnetic layer 110 dose not react with the internal electrode 120 formed by copper in the sintering process.

The ferrite magnetic layer 110 may be formed by stacking and sintering a plural of platy ferrite green body.

Preferably, the ferrite magnetic layer 110 forms to have the grain size of 0.2 μm˜10 μm. To be more specific, the ferrite magnetic layer 110 can be formed to have the grain size of 0.2 μm˜1.0 μm by adjusting a size of Mn—Zn based ferrite powder or Mn—Mg—Zn based ferrite powder and by adjusting an oxygen partial pressure of a reducing atmosphere in a sintering process. If a the grain size of the ferrite magnetic layer 110 is too small, there is a problem that the permeability of the ferrite magnetic layer 110 is reduced. If the grain size of the ferrite magnetic layer 110 is too large, there is a problem that an using frequency domain of the ferrite magnetic layer 110 is reduced. The using frequency domain of the ferrite magnetic layer 110 can be increased to 1˜10 MHz in case that the ferrite magnetic layer 110 is formed by Mn—Zn based ferrite. The using frequency domain of the ferrite magnetic layer 110 can be increased to 1˜20 MHz in case that the ferrite magnetic layer 110 is formed by Mn—Mg—Zn based ferrite. Also, the ferrite magnetic layer 110 has the permeability of 100˜400 in 3 MHz.

The internal electrode 120 is made of copper. The internal electrode 120 is shaped as a coil shape inside the ferrite magnetic layer 110. In more detail, the internal electrode 120 is shaped in a ring shape of a closed curve such as circle or rectangle and of having an open portion inside the ferrite magnetic layer 110. Also, the internal electrode 120 is formed to form a plural of plane layers which are arranged separately each other inside the ferrite magnetic layer 110. Each plane layer of the internal electrode is coupled electrically each other at one end of plane layer by an internal connecting electrode (not shown) which is formed of copper inside the ferrite magnetic layer 110. Also, the internal electrode 120a is formed for a top end of that to expose from one side surface of the ferrite magnetic layer 110. Here, the internal electrode 120a is formed inside the upper portion of the ferrite magnetic layer 110 among the internal electrode 120. Also, the internal electrode 120b is formed for a bottom end to expose from one side surface of the ferrite magnetic layer 110. Here, the internal electrode 120b is formed inside the lower portion of the ferrite magnetic layer 110 among the internal electrode 120. Although not shown in FIG. 1, the internal electrodes 120a 120b which are formed in a upper and lower portion may be formed to expose from top surface and bottom surface of the ferrite magnetic layer 110 respectively.

Since the internal electrode 120 is made of copper and the ferrite magnetic layer 110 is made of Mn—Zn based ferrite or Mn—Mg—Zn based ferrite and is not comprised copper, the internal electrode 120 does not react with the ferrite magnetic layer 110 in sintering process of the ferrite magnetic layer 110. Therefore, the internal electrode 120 can act as an electrode after sintering process of the ferrite magnetic layer 110.

The external electrode 130 is formed on both side surface or top-bottom surface of the ferrite magnetic layer 110 and is coupled electrically to the internal electrodes 120a and 120b which are exposed from both side surfaces or upper and lower surfaces of the ferrite magnetic layer 110. The external electrode 130 is made of copper, nickel, silver or silver-palladium alloy.

Secondly, a method of manufacturing a multilayered chip-type power inductor according to embodiment of the present invention is described.

FIG. 2 is a process chart of a method of manufacturing a multilayered chip-type power inductor according to one embodiment of the present invention.

Referring to FIG. 2, the method of manufacturing a multilayered chip-type power inductor according to one embodiment of the present invention includes green stacked body forming step S10, green stacked body sintering step S20 and external electrode forming step S30.

Green stacked body forming step S10 is forming a green stacked body by stacking a plurality of green formed body. The green formed body is formed by forming Mn—Mg—Zn based ferrite powder into a plate shape and forming an internal electrode on the plate shape by printing copper. The ferrite powder is formed by mixing each powder in a scope of MnO 20-40 mol %, MgO 0-10 mol %, Fe₂O₃ 50-55 mol %, ZnO 9-25 mol % according to a composition of the ferrite magnetic layer 110 of inductor to be manufactured.

First, the ferrite powder is formed by weighing and mixing Mn₃O₄ powder, MgCO₃ powder, ZnO powder and Fe₂O₃ powder according to a final composition of the ferrite magnetic layer 110. Also, secondly, the ferrite powder is formed by ball milling and by calcining in a reducing atmosphere such as nitrogen atmosphere. At this time, a calcining temperature may be 700˜750° C. The ferrite powder is formed finally by ball milling and spray-drying the calcined powder. At this time, the ferrite powder is milled to have specific surface area of 10-40 m²/g.

The green formed body is formed by forming the ferrite powder into a plate shape of predetermined thickness. The internal electrode is formed by printing copper of predetermined thickness into a partial open curved line such as circle or rectangle on top surface and/or bottom surface of the green formed body. The green formed body has a via hole through from top surface to bottom surface and an internal connecting electrode which is formed inner side of the via hole by copper. The internal connecting electrode connect electrically the internal electrodes formed on each green formed body. Therefore, the green stacked body is comprised an electrode which is formed by the internal electrode and the internal connecting electrode connecting the internal electrodes in a coil shape inside of itself.

Also, the internal electrode 120 is formed to expose from one side and other side surface or top and bottom surface of the green stacked body. That is, the green formed body which is positioned in upper and lower portion of the green stacked body is formed to expose the internal electrode from one side and other side surface or top and bottom surface of itself.

Meanwhile, green stacked body forming step S10 may comprise to form the green stacked body by proceeding alternately magnetic green layer coating process and internal electrode coating process.

Magnetic green layer application process is proceeded by coating a paste which include a Mn—Zn based ferrite powder or a Mn—Mg—Zn based ferrite powder and a binder and a solvent on a substrate such as a resin film.

The ferrite powder and the binder and the solvent are mixed and formed into the paste by method such as ball mill. The binder and the solvent may be used by a binder and a solvent which is used generally in manufacturing multilayered chip-type power inductor. The magnetic green layer can be coated by a method such as doctor blade method or screen printing method. Also, the magnetic green layer can be coated by a general method used in coating a paste.

Internal electrode coating process is progressed by screen printing a paste including a copper powder and a binder and a solvent on the magnetic green layer.

Green stacked body forming step S10 is progressed by a variety of common method used in manufacturing multilayered chip-type power inductor. For example, magnetic green layer coating process and internal electrode coating process are repeated by turns, the internal electrodes are connected each other overall. In more detail, first, after a magnetic green layer which arrange at a lower portion of a green magnetic body is coated to have the same area with the power inductor, an internal electrode is formed partially on the ferrite green layer. At this time, the internal electrode is exposed from one side surface of the magnetic green layer. Next, other magnetic green layer is formed to expose a partial portion of the internal electrode layer which is coated on a top surface of other magnetic green layer. The other magnetic green layer is formed above the magnetic green layer. Next, while the internal electrode layer is coated on the top surface of the other magnetic green layer, the internal electrode layer connects to the internal electrode layer which is coated on the magnetic green layer positioned at the lower portion. The green magnetic body is formed by repeating processes described above. Also, the magnetic green layer which arrange at a upper portion is coated to have the same area with the magnetic green layer which is coated at a lower portion. At this time, an internal electrode layer which is formed at a bottom surface of the magnetic green layer arranged at a upper portion is formed to expose from other side surface of the magnetic green layer. Therefore, the green magnetic body has an overall shape of hexahedron, and includes the internal electrode layers which are connected overall inside it. Also, the internal electrode layers are formed to expose from the one and other side surfaces of the magnetic green layer.

Green stacked body sintering step S20 is forming a sintered stacked body by sintering the green stacked body in the reducing atmosphere. Here, the sintered stacked body means to include the ferrite magnetic layer and the internal electrode which is formed inside the ferrite magnetic layer.

Green stacked body sintering step S20 is proceeded in the reducing atmosphere. Therefore, green stacked body sintering step S20 is proceeded in a nitrogen atmosphere or in a mixed atmosphere of nitrogen and hydrogen. Also, green stacked body sintering step S20 is proceeded in an atmosphere of 10⁻¹² to 10⁻⁶ atm of an oxygen partial pressure. Therefore, copper does not oxidize in the sintering process and can form the internal electrode. If the oxygen partial pressure is less than 10⁻¹² atm, there is a problem that a secondary phase of wustite is generated in the sintering process of the magnetic green layer and reduce a magnetic property of the ferrite magnetic layer. If the oxygen partial pressure is more than 10⁻⁸ atm, there is a problem that copper of the internal electrode may be oxidized. Also, the internal electrode does not react with the ferrite magnetic layer.

The sintered stacked body is sintered to have the grain size of 0.2 μm˜1.0 μm in the reducing atmosphere. Therefore, the sintered stacked body is formed to have a using frequency domain of 1˜10 MHz in case that the ferrite magnetic layer is formed by Mn—Zn based ferrite. Also, the using frequency domain of the sintered stacked body is increased to 20 MHz due to effect of MgO in case that the ferrite magnetic layer is formed by Mn—Mg—Zn based ferrite.

Also, green stacked body sintering step S20 is proceeded in a sintering temperature range of 900° C.˜1030° C. lower than 1080° C., a melting point of copper. If the sintering temperature is lower than 900° C., there is a problem that sintering of the green stacked body may be done poorly. Also, if the sintering temperature is higher than 1030° C., there is a problem that copper of the internal electrode layer may be melting partially and the internal electrodes cannot be connected as a whole.

External electrode forming step S30 is forming external electrodes which are connected electrically to the internal electrodes at both side surfaces or top and bottom surfaces respectively. The external electrodes are made of copper, nickel, silver or silver-palladium alloy and formed by deposition method, plating method or sputtering method in external electrode forming step S30. Also, External electrode forming step S30 can form the external electrode by using a common method which is forming a metal thin film.

The present invention will now be described in more detail hereinafter with reference to the specific embodiments.

### Embodiment 1

First, Mn₃O₄ powder, ZnO powder and Fe₂O₃ powder was weighed to be MnO 30 mol %, ZnO 20 mol %, Fe₂O₃ mol % according to a composition of the ferrite magnetic layer as shown Table 1, mixed and milled to a mixed powder by ball mill. The mixed powder calcined at a temperature of 750° C. and in nitrogen atmosphere. The calcined powder was crushed in a ball mill again and was formed into a ferrite powder by spray drying. At this time, the ferrite powder was crushed to have a specific surface area of about 30 m²/g. The ferrite powder was molded into a tolloid core green compact to have a molding density of about 3 g/cm³ by pressing. The tolloid core green compact was formed into a sintered body by sintering in an atmosphere of an oxygen partial pressure of 10⁻¹² atm and at a sintering temperature of 935° C. A magnetic property of the sintered body was measured by winding copper wire on the outside of the sintered body.

### Embodiment 2

In embodiment 2, as shown in table 1, a sintered body was formed under the same conditions as in embodiment 1 except the composition of the ferrite magnetic layer and the sintering temperature.

### Embodiment 3

In embodiment 3, as shown in table 1, a sintered body was formed under the same conditions as in embodiment 1 except the sintering temperature and the oxygen partial pressure.

### Embodiment 4

In embodiment 4, as shown in table 1, a sintered body was formed under the same conditions as in embodiment 1 except the composition of the ferrite magnetic layer and the sintering temperature.

### Embodiment 5

In embodiment 5, as shown in table 1, a sintered body was formed under the same conditions as in embodiment 1 except the composition of the ferrite magnetic layer and the sintering temperature.

### Embodiment 6

In embodiment 6, as shown in table 1, a sintered body was formed under the same conditions as in embodiment 1 except the composition of the ferrite magnetic layer and the sintering temperature and the oxygen partial pressure.

### Embodiment 7

In embodiment 7, as shown in table 1, a sintered body was formed under the same conditions as in embodiment 1 except the composition of the ferrite magnetic layer and the sintering temperature.

### Comparative Embodiment 1

In comparative embodiment 1, as shown in table 1, a sintered body was formed under the same conditions as in embodiment 1 except the sintering temperature.

### Comparative Embodiment 2

In comparative embodiment 2, as shown in table 1, a sintered body was formed under the same conditions as in embodiment 1 except the composition of the ferrite magnetic layer and the sintering temperature and the oxygen partial pressure.

### Comparative Embodiment 3

In comparative embodiment 3, as shown in table 1, a sintered body was formed under the same conditions as in embodiment 1 except the composition of the ferrite magnetic layer and the sintering temperature.

TABLE 1
Table 1. composition and sintering
condition of embodiments and comparatives

| | | | | | | Sintering |
|---|---|---|---|---|---|---|
| | | | | | sintering | oxygen |
| | MnO | ZnO | Fe₂O₃ | MgO | temperature | pressure |
| | mol % | | | | ° C. | atm |
| embodiment 1 | 30.0 | 20.0 | 50.0 | 0.0 | 935 | 10⁻¹¹ |
| embodiment 2 | 25.0 | 22.5 | 52.5 | 0.0 | 955 | 10⁻¹¹ |
| embodiment 3 | 25.0 | 22.5 | 52.5 | 0.0 | 955 | 10⁻⁷ |
| embodiment 4 | 20.0 | 22.5 | 52.5 | 5.0 | 955 | 10⁻¹¹ |
| embodiment 5 | 35.0 | 11.0 | 54.0 | 0.0 | 955 | 10⁻¹¹ |
| embodiment 6 | 35.0 | 11.0 | 54.0 | 0.0 | 955 | 10⁻⁷ |
| embodiment 7 | 36.0 | 9.0 | 55.0 | 0.0 | 955 | 10⁻¹¹ |
| comparative 1 | 30.0 | 20.0 | 50.0 | 0.0 | 1050 | 10⁻¹¹ |
| comparative 2 | 10.0 | 22.5 | 52.5 | 15.0 | 955 | 10⁻¹¹ |
| comparative 3 | 37.0 | 8.0 | 55.0 | 0.0 | 850 | 10⁻¹¹ |

As shown in table 2, the grain size and permeability were evaluated for the sintered body of embodiments and comparative embodiments.

TABLE 2
Table 2. Test Result of embodiments and comparatives

| | |
|---|---|
| grain size | permeability |

| | μm | 1 MHz | 3 MHz |
|---|---|---|---|
| embodiment 1 | 0.4 | 206 | 209 |
| embodiment 2 | 0.5 | 331 | 354 |
| embodiment 3 | 0.3 | 155 | 155 |
| embodiment 4 | 0.2 | 125 | 126 |
| embodiment 5 | 0.6 | 214 | 213 |
| embodiment 6 | 0.4 | 158 | 155 |
| embodiment 7 | 0.8 | 235 | 236 |
| comparative 1 | 1.5 | 850 | 280 |
| comparative 2 | 0.15 | 56 | 56 |
| comparative 3 | 0.1 | 63 | 64 |

The sintered bodies of embodiment 1 to 7 were measured to have a grain size of 0.2 μm to 0.8 μm. As shown FIG. 3, it can be seen that the sintered body of embodiment 1 had an uniform grain size.

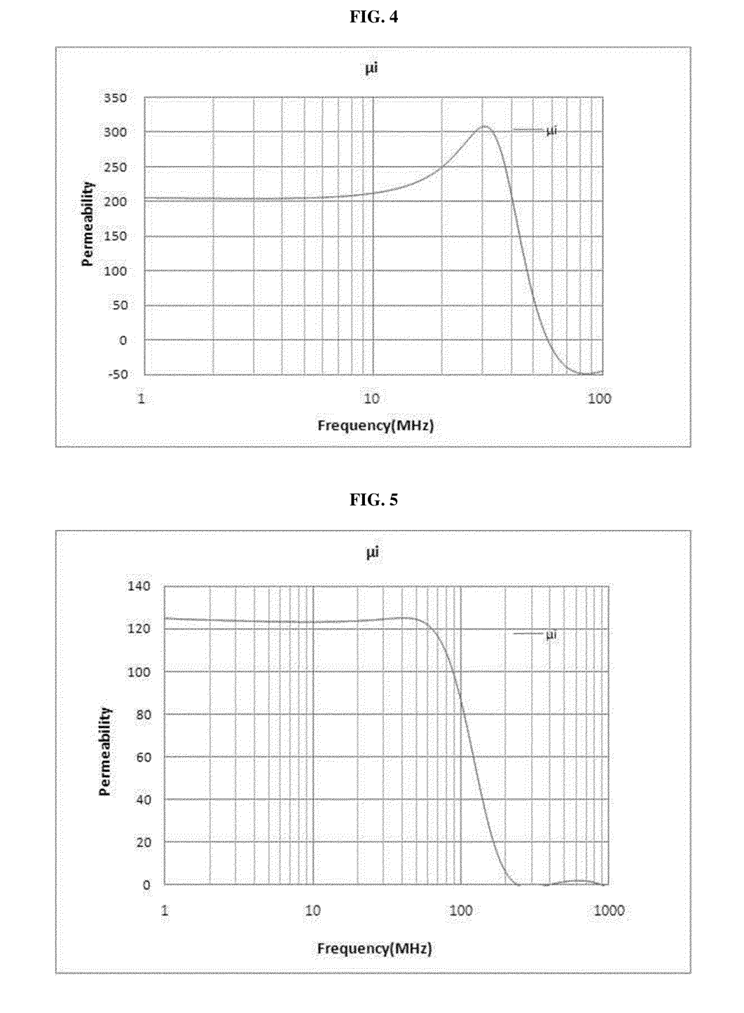

Also, the sintered bodies of embodiment 1 to 7 have shown the permeability of 125 to 331 at 1 MHz, the permeability of 126 to 354 at 3 MHz. The permeability of 1 MHz and 3 MHz were appeared to be little or no difference in embodiment 1 to 7. As shown FIG. 4, it can be seen that the using frequency domain of embodiment 1 was 1˜10 MHz. As shown FIG. 5, it can be seen that the using frequency domain of embodiment 4 included MgO 5 mol % was increases to 20 MHz.

However, it can be seen that although comparative embodiment 1 had a grain size of 1.5 μm and the permeability of 850 at 1 MHz, the using frequency domain was low because of the permeability of 280 at 3 MHz. Also, it can be seen that comparative embodiment 2 and 3 had a grain size of 0.15 μm all and 0.1 μm all respectively and had a very low permeability.

Next, it was evaluated that whether the ferrite magnetic layer was reacted with the internal electrode of copper according to embodiments of the present invention.

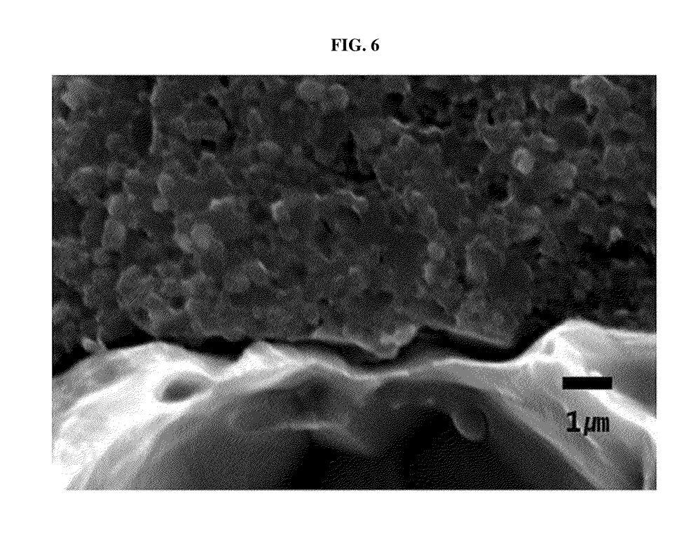

First, after a copper electrode was inserted into a ferrite powder having a ferrite composition of embodiment 4, a sintered body was prepared by sintering the ferrite powder in the conditions of embodiment 4. After a portion which the copper electrode was located in the sintered body was fractured, an interface of the ferrite magnetic layer and the internal electrode was observed. As shown in FIG. 6, it can be seen that the ferrite magnetic layer (a dark portion of upper part) and the internal electrode (a light portion of lower part) did not react each other between two sides to be faced. Meanwhile, it has occurred in a cutting process of the sintered body that the interface between the ferrite magnetic layer and the internal electrode was separated.

It will be understood by those of ordinary skill in the art that various changes in form and details may be made without departing from the spirit and scope of the present invention as set forth in the above embodiments.

### REFERENCE NUMERALS

100: multilayered chip-type power inductor

110: ferrite magnetic layer 120: internal electrode

130: external electrode

1. A multilayered chip-type power inductor comprising;
a plurality of staked ferrite magnetic layers made of Mn—Zn based ferrite or Mn—Mg—Zn based ferrite;
an internal electrode made of copper, shaped as a coil shape inside the ferrite magnetic layers and exposed from both side surfaces or upper and lower surfaces of the ferrite magnetic layers; and
an external electrode electrically coupled to the internal electrode which is exposed from both side surface or upper and lower surfaces of the ferrite magnetic layer.

2. The multilayered chip-type power inductor of claim 1, wherein each of the ferrite magnetic layers comprises MnO 20˜40 mol %, MgO 0˜10 mol %, Fe₂O₃ 50˜55 mol %, ZnO 9˜25 mol %.

3. The multilayered chip-type power inductor of claim 1, wherein an using frequency domain of each of the ferrite magnetic layers is 1˜10 MHz in case that each of the ferrite magnet layers is made of Mn—Zn based ferrite.

4. The multilayered chip-type power inductor of claim 1, wherein each of the ferrite magnetic layers has a grain size of 0.2 μm˜1.0 μm.

5. A method of manufacturing a multilayered chip-type power inductor, the method comprising:
forming green stacked body by stacking a green formed body which is formed by forming a Mn—Mg—Zn based ferrite powder into a plate shape and forming an internal electrode on the plate shape by printing copper;
sintering green stacked body by sintering the green stacked body in a reducing atmosphere; and
forming an external electrode electrically connected respectively to the internal electrode which is exposed from both side surfaces or upper and lower surfaces of the sintered stacked body.

6. The method of manufacturing a multilayered chip-type power inductor of claim 5, wherein the sintering green stacked body is proceeded in a sintering temperature range of 900° C.˜1030° C.

7. The method of manufacturing a multilayered chip-type power inductor of claim 5, wherein the sintering green stacked body is proceeded in a nitrogen atmosphere or in a mixed atmosphere of nitrogen and hydrogen.

8. The method of manufacturing a multilayered chip-type power inductor of claim 5, wherein the sintering green stacked body is proceeded in an atmosphere of 10⁻¹²˜10⁻⁶ atm of an oxygen partial pressure.

9. The method of manufacturing a multilayered chip-type power inductor of claim 5, wherein:
the sintered stacked body comprises a plurality of ferrite magnetic layers and the internal electrode which is formed in a coil shape inside the ferrite magnetic layers and is exposed from both side surfaces or upper and lower surfaces of the ferrite magnetic layer,
the external electrode electrically connected to the internal electrode exposed from both side surfaces or upper and lower surfaces of the ferrite magnetic layers.

10. The method of manufacturing a multilayered chip-type power inductor of claim 9, wherein each of the ferrite magnetic layers has a grain size of 0.2 μm˜1.0 μm.

11. The method of manufacturing a multilayered chip-type power inductor of claim 9, wherein an using frequency domain of each of the ferrite magnetic layers is 1˜10 MHz in case that each of the ferrite magnet layers is made of Mn—Zn based ferrite.

12. The method of manufacturing a multilayered chip-type power inductor of claim 9, wherein each of the ferrite magnetic layers has MnO 20˜40 mol %, MgO 0˜10 mol %, Fe₂O₃ 50˜55 mol %, ZnO 9˜25 mol %.

13. The multilayered chip-type power inductor of claim 1, wherein the external electrode is made from at least one material selected from the group consisting of copper, nickel, silver, and silver-palladium.

14. The multilayered chip-type power inductor of claim 1, wherein an using frequency domain of each of the ferrite magnetic layers is 1˜20 MHz in case that each the ferrite magnet layers are made of Mn—Mg—Zn based ferrite.

15. The multilayered chip-type power inductor of claim 3, wherein each of the ferrite magnetic layers has permeability of 100˜400 in 3 MHz.

16. The multilayered chip-type power inductor of claim 14, wherein each of the ferrite magnetic layers has permeability of 100˜400 in 3 MHz.

17. The method of manufacturing a multilayered chip-type power inductor of claim 5, wherein the external electrode is made from at least one material selected from the group consisting of copper, nickel, silver, and silver-palladium.

18. The method of manufacturing a multilayered chip-type power inductor of claim 9, wherein an using frequency domain of each of the ferrite magnetic layers is 1˜20 MHz in case that each of the ferrite magnet layers is made of Mn—Mg—Zn based ferrite.

19. The method of manufacturing a multilayered chip-type power inductor of claim 11, wherein each of the ferrite magnetic layers has permeability of 100˜400 in 3 MHz.

20. The method of manufacturing a multilayered chip-type power inductor of claim 18, wherein each of the ferrite magnetic layers has permeability of 100˜400 in 3 MHz.
